(19) United States
(12) Patent Application Publication
(10) Pub. No.: US 2008/0215581 A1
(43) Pub. Date: Sep. 4, 2008

(54) CONTENT/METADATA SELECTION AND PROPAGATION SERVICE TO PROPAGATE CONTENT/METADATA TO CLIENT DEVICES

(76) Inventors: Bill Messing, Seattle, WA (US); Michael Hyman, Bellevue, WA (US); Jan S. Drake, Seattle, WA (US); Nils B. Lahr, Redmond, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/870,402

(22) Filed: Oct. 10, 2007

Related U.S. Application Data
(60) Provisional application No. 60/850,838, filed on Oct. 10, 2006.

(51) Int. Cl. G06F 17/30

(52) U.S. Cl. 707/6; 707/E17.001

(57) ABSTRACT

In various embodiments, one or more servers is (collectively) endowed with a core data collection and management service, and a core content/metadata selection and propagation service, to receive from client devices automatically collected user activity associated data and in response, to select and propagate content/metadata to the client device, in a more efficient, flexible and effective manner (with high relevancy).

### RELATED APPLICATIONS

The present non-provisional application claims priority to provisional application No. 60/850,838, entitled Relevant Content Recommendation System, filed on Oct. 10, 2006.

### TECHNICAL FIELD

The present invention relates generally to the fields of data processing and information technology. More specifically, embodiments of the present invention relate to a service for selecting and propagating content and/or metadata to client device, which applications include selecting and propagating user created content via the World Wide Web (WWW).

### BACKGROUND

With advances in computing, networking and related technologies, more and more computing devices are networked together, with more and more content available to the networked computing users. For example, billions of content pages/objects are available on the WWW for Internet users. However, publication and propagation of contents in a relevant manner, that is publishing and propagating content to those would be interested, remain a challenge.

For example, social networks on the Internet have become very popular in recent years. Social networks typically consist of two main elements: 1) users; and 2) the content within the network, such as home pages and images, that the users come to the network to view. For a network to become successful, it must attract users who will both produce and consume content. In the social networks that exist today, content is typically produced (i.e. published) by users using a traditional publishing approach. That is, when a user has something he or she decides to share, the user uses the social network system to create (publish) the content—for example by writing a blog entry, by uploading an image, or by rearranging his or her home page. This set of explicit actions lets a user construct a representation, available for others to view, of his or her personality and interests, or persona. This approach allows for the display of a breadth of content, but it requires users to actively update their content in order to maintain the interest of viewers. Because updating content is labor-intensive for the publisher, sites typically have a very large difference between the number of people viewing and the number of people creating content, sometimes as much as 100:1. This means that the social network system must attract a very large number of people in order to have enough actively changing content to generate repeat traffic. Typically such social network systems have a large number of publishers who create an initial page and then rarely or never update it. Likewise, the abandonment rate of viewers is also often high. Viewers must be dedicated in order to find new and interesting content. Thus, increased automation in content publication and propagation in a relevant manner would be desirable.

There are a number of websites, most notably Amazon and Netflix, as well as startups such as Findory, that provide recommendation systems. These look at historical purchases people have made, or content they have viewed, and from them construct suggestions for additional purchases or information. These systems often use a cosine similarities algorithm.

For the distribution of user created content, e.g. in the context of a social network, the simple approach of using cosine similarities algorithm doesn't work well. The distribution of user created content involves a large number of discrete content items, little of which actually gets purchased, much of which is not catalogued in detail, and much of which is not viewed frequently.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of various embodiments of the present invention;

FIG. 2 illustrates selected components of a content/metadata selection and propagation service, including selected operations, in accordance with various embodiments of the present invention;

FIG. 3 illustrates an example computer system suitable for use as a client device to practice various embodiments of the present invention;

FIG. 4 illustrates selected operations for selecting relevant content employing multiple relevance analysis algorithms, in accordance with various embodiments;

FIG. 5 illustrates selected operations for selecting relevant content based on user activities on friend's client devices, in accordance with various embodiments;

FIG. 6 illustrates selected operations for selecting relevant content through a cosine similarity approach, in accordance with various embodiments;

FIG. 7 illustrates selected operations for selecting relevant content through a cosine similarity analysis of metadata, in accordance with various embodiments;

FIG. 8 illustrates selected operations for associating algorithm analysis results with content; in accordance with various embodiments;

FIG. 9 illustrates selected operations for selecting relevant content through use of Bayesian network, in accordance with various embodiments; and

FIG. 10 illustrates selected operations for selecting relevant content by experimenting with “new” content, in accordance with various embodiments.

### DETAILED DESCRIPTION OF ILLUSTRATIVE EMBODIMENTS

Illustrative embodiments of the present invention include, but are not limited to, methods and apparatuses for receiving from client devices automatically collected user activities associated data, and for selecting and propagating content and/or metadata back the client devices in a more efficient, flexible and effective (with high relevancy) manner. The methods and apparatuses having particular application to selection and propagation of relevant user created content in a social network.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

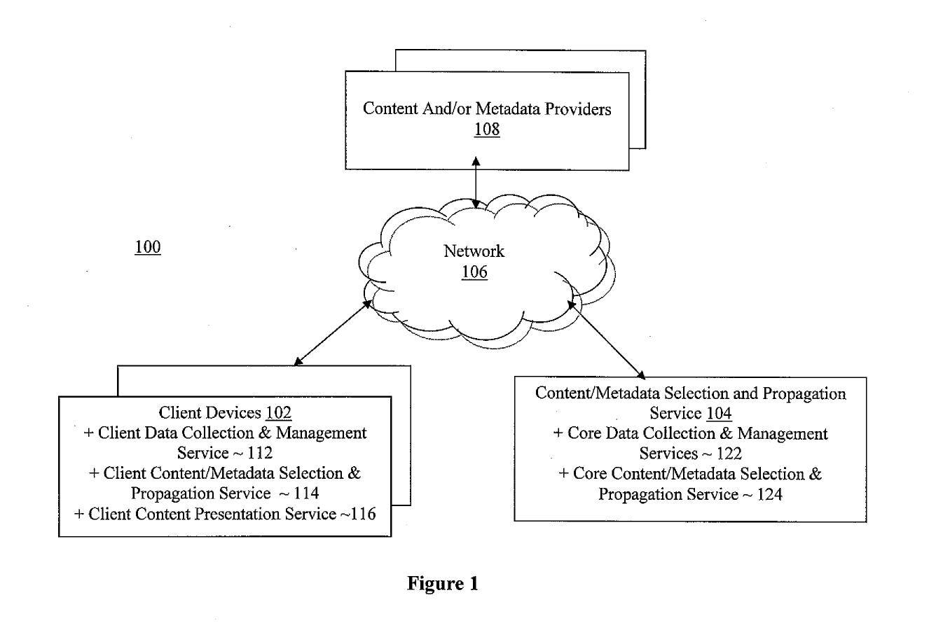

FIG. 1 illustrated as overview of the present invention, in accordance with various embodiments. Illustrated therein are a number of client devices 102, a content/metadata selection and propagation service 104, and a number of content/metadata providers 108 coupled to each other via network 106. Service 104 is endowed with the teachings of the present invention to receive from client devices 102 automatically collected user activities related data, and in response, to select and propagate relevant content/metadata back to client devices 102. More specifically, for the embodiments, content/metadata selection is endowed with a core data collection and management service 122 and a core content/metadata selection service 124. Core data collection and management service 122 is configured to receive automatically collected user activities associated data from client devices 102. The data may comprise both actively associated as well as passively associated data. The data may be filtered/unfiltered, modified/unmodified, and/or analyzed/unanalyzed. Core content/metadata selection service 124 is configured in response to select and propagate relevant content/metadata. Various embodiments of service 124 will be further described in more detail below.

Content/metadata selection and propagation service 104 may be implemented on a single central computer or a collection of servers, e.g. a cluster of locally networked servers, or a system of distributed servers coupled via one or more local/wide area networks. The various networks may comprise wired or wireless segments/domains.

The term “content/metadata” as used herein means content and/or metadata. Content may be commercial or non-commercial in nature, may be public or private, and may be text, graphics, video, audio or multi-media in form. Metadata may be a wide range of data describing technical and/or substantive attributes of the content. Accordingly, each of content/metadata providers may be any one of a wide range of such providers, including but not limited to a commercial or non-commercial website, a video and/or audio service, and so forth.

For the illustrated embodiments, each client device 102 may be endowed with at least a client data collection and management service 112, a client content/metadata selection and propagation service 114 and a client content presentation service 116. Services 112 and 114 may be configured complementarily to services 122 and 124. Various implementations of services 112, 114 and 116 are the subject matters of co-pending application entitled “Automated User Activity Associated Data Collection and Reporting for Content/Metadata Selection and Propagation Service”, having common inventorship with the subject application, and contemporaneously filed (application number to be assigned). For further details of services 112-116, readers are referred to the co-pending application.

Each of client devices 102 may be any one of a broad range of computing or processor based devices known in the art or to be developed, including but not limited to, desktop computers, notebook computers, palm-sized hand-held computing devices, personal digital assistants, smart phones, game consoles, set top boxes, and so forth.

Network 106 may comprise one or more wired and/or wireless, local and/or wide area networks.

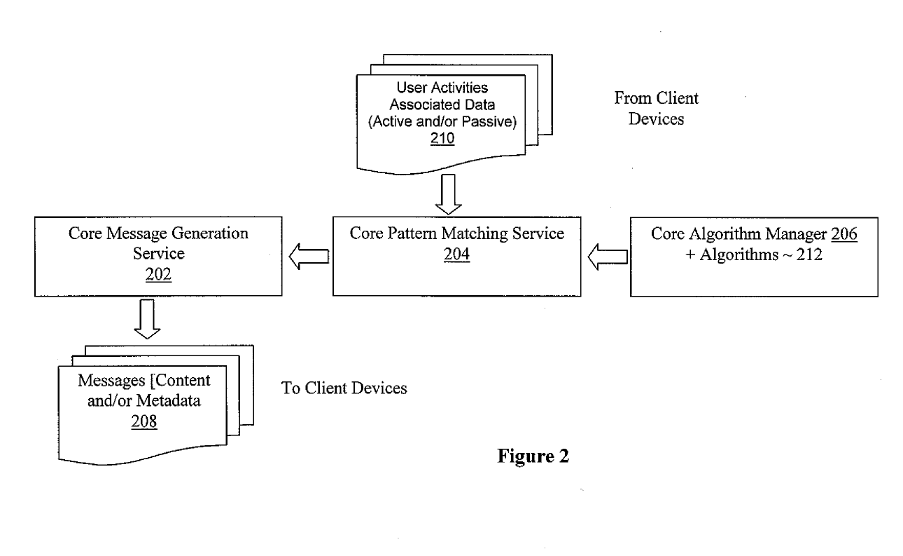

Referring now to FIG. 2, wherein selected components of core content/metadata selection and propagation service 124, and their operations, in accordance with various embodiments, are illustrated. As shown, for the embodiments, core content/metadata selection and propagation service 124 may comprise a core message generation service 202, a core pattern matching service 204, various pattern analysis algorithms 212, and a core algorithm manager 206, operatively coupled to each other as shown.

Content message generation service 202 is configured to generate messages comprising content and/or metadata 208 for selection and propagation to the various client devices. Core pattern matching service 204 is configured to perform patterns detection for client devices 102, discerning patterns from reported user activities 210 on client devices, and/or relevancy between content and the client devices.

In various embodiments, core pattern matching service 204 performs the pattern detection and relevance determination for client devices, employing a number of pattern/relevance analysis algorithms 212. Pattern analysis algorithms 212 may be any one of such analysis algorithms known in the art or to be devised. Examples of these pattern/relevancy analysis algorithms 212 include but are not limited to cosine similarity algorithm, Bayesian network, and so forth. However, preferably the pattern/relevance analysis algorithms 212 complement each other, in that one pattern/relevance algorithm's strength compensate at least in part the weakness of another pattern/analysis relevance algorithm. For the embodiments, algorithms 212 are maintained and managed by core algorithm manager 206. In various embodiments, algorithm manager 206 also manages the algorithms to be employed for local pattern/relevance analysis on client devices 102 (see co-pending application for details).

In various embodiments, the messages 208 are propagated to the client devices based on their relevance to the various client devices. In various embodiments, the messages 208 propagated to each client device are locally merged with messages locally generated on the particular client device 102 and presented on the client devices 102 respectively (see copending application for further detail.)

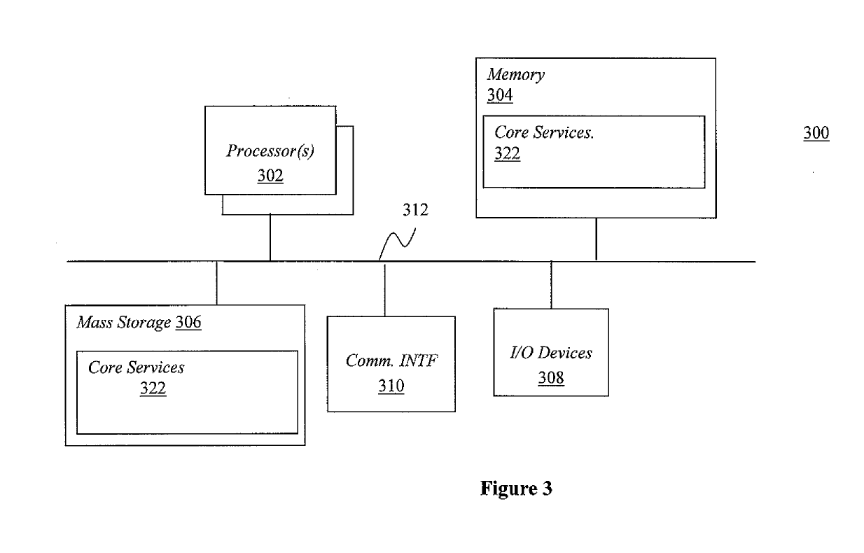

FIG. 3 illustrates an example computer system suitable for use as a server to practice various embodiments of the present invention. As shown, computing system 300 includes a number of processors or processor cores 302, and system memory 304. For the purpose of this application, including the claims, the terms “processor” and “processor cores” may be considered synonymous, unless the context clearly requires otherwise. Additionally, computing system 300 includes mass storage devices 306 (such as diskette, hard drive, compact disc read only memory (CDROM) and so forth), input/output devices 308 (such as display, keyboard, cursor control and so forth) and communication interfaces 310 (such as network interface cards, modems and so forth). The elements are coupled to each other via system bus 312, which represents one or more buses. In the case of multiple buses, they are bridged by one or more bus bridges (not shown).

Each of these elements performs its conventional functions known in the art. In particular, system memory 304 and mass storage 306 may be employed to store a working copy and a permanent copy of the programming instructions implementing, in whole or in part, services 122 and 124 (core services), including the various components illustrated in FIG. 2, collectively denoted as 322. The various components may be implemented by assembler instructions supported by processor(s) 302 or high-level languages, such as C, that can be compiled into such instructions.

The permanent copy of the programming instructions may be placed into permanent storage 406 in the factory, or in the field, through, for example, a distribution medium (not shown), such as a compact disc (CD), or through communication interface 410 (from a distribution server (not shown)). That is, one or more distribution media having an implementation of the agent program may be employed to distribute the agent and program various computing devices.

The constitution of these elements 302-312 are known, and accordingly will not be further described.

### Application to Providing Relevant Content in a Social Network

As alluded earlier, above described embodiments of the present invention may be practiced to providing relevant content to client devices in a social network, including content created by users of the client devices, thus enabling the social network to propagate and present to each user of the system a set of constantly changing content that the user will likely find interesting (relevant).

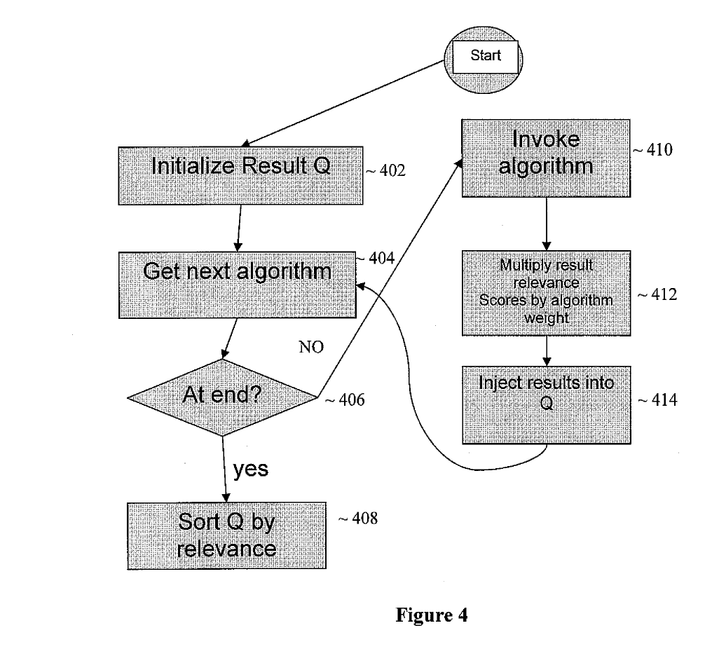

FIG. 4 illustrates selected operations for selecting relevant content employing multiple analysis algorithms, in accordance with various embodiments. As illustrated, a result queue for a client device may first be initialized, 402, and if all analysis algorithm have not been invoked, 406, the next relevant algorithm analysis is invoked 410. In various embodiments, the analysis algorithms may be invoked in any arbitrary order. For the embodiments, the relevant algorithm analysis 410 returns a relevance score at completion of the analysis. At 412, the relevance score is normalized by the importance/weight of the algorithm, and the result is stored into the content result queue, 414. In due course, all relevance algorithm analysis would have been performed, at such time, the content queue may be sorted by the content's relevance, 408.

In various embodiments, the relevant content service may be designed such that additional relevance algorithms may be added at any time. Each relevance algorithm is given a unique identifier. The relevant content service stores the relevance weight that each relevance algorithm provides for the content that the relevant content service surfaces, and records the resulting clickthrough rates on that content. The relevant content service then back-propagates a score to the relevance algorithms that suggested the content, weighted by their relevance score. Thus, a relevance algorithm that gave high relevance to a piece of content that was clicked on will get a large bonus.

In various embodiments, the relevant content service uses these weights as the weighting score discussed previously. As a result, relevance algorithms that are most effective for a particular user will gain increasing influence in selecting content for that user.

Additionally, the relevant content service gives a score to the overall performance of each relevance algorithm across the entire set of users, and combines that score with the per-user score to determine actual weighting in the use of that algorithm for that particular user. This has the value of damping out spikes that might occur due to a very short term behavior pattern of a user. (E.g., the user might heavily click on one content base and overly highly weight a particular relevance algorithm.)

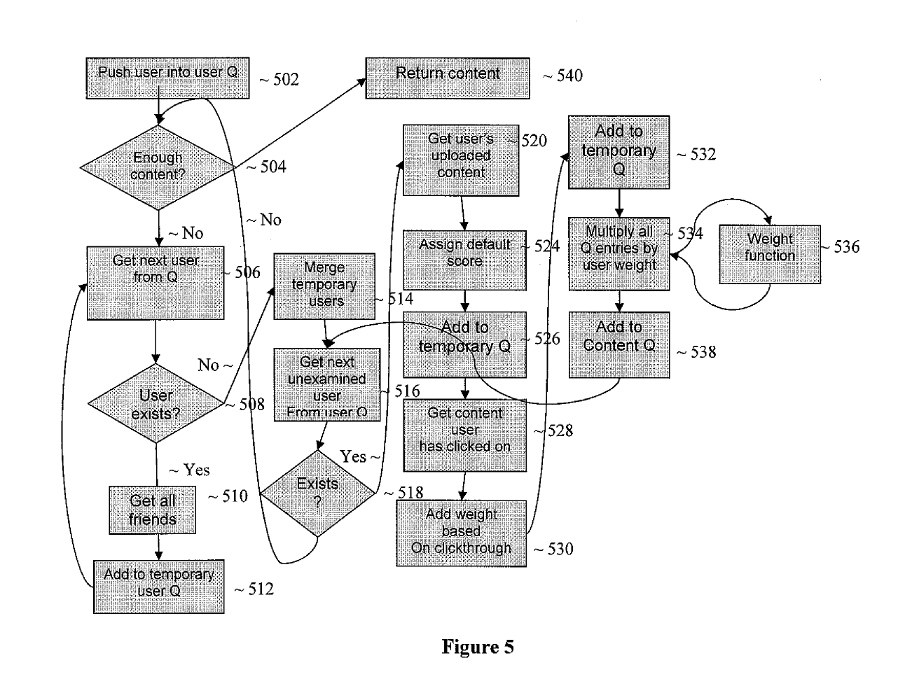

FIG. 5 illustrates selected operations for selecting relevant content based on user activities on friends' client devices, in accordance with various embodiments. For these embodiments, when additional content is needed, 504, the relevant content service may make the relevant predictions by looking at a user's social network, looping through all “friends” of the user, 506-538. From that, the relevant content service looks for content that the relevant content service can recommend, based upon both what people in the social network have recently uploaded, 520, as well as what people in the network have recently clicked on, 528. In various embodiments, the relevant content service weighs the values of the content based upon the strength of the connections between the user requesting content and the person who created or uploaded it, 534-538. Eventually, after sufficient relevant content has been accumulated, the relevant content service propagates the content to the client device 540.

In various embodiments, the strength is a function of explicit statements such as ‘best friend’, as well as implicit voting based upon clickthroughs or other response activity. The strength of a connection drops with distance. Thus people a user knows will have a much stronger weight than people who are known only by people that the user knows. (For example, suppose user A knows user B. User B knows user C. User C knows user D. User A doesn't know user C or D. Suppose user B and user D have clicked on the content. The combined strength would be f(1)+f(3), where f is a distance function. Here, “1” represents the distance between user A and user B, and “3” represents the distance between user A and user D. {In this context, distance may also be referred to as “degree of removal”). The function f could be any one of a number of functions with an “inversely proportional” behavior. An example of such a function is 1/n². In other words, the various embodiments assume that people in a social network have enough of a relationship that they will have some common interests or behaviors, but that this commonality drops off with distance (or degree of removal) in a non-linear fashion.

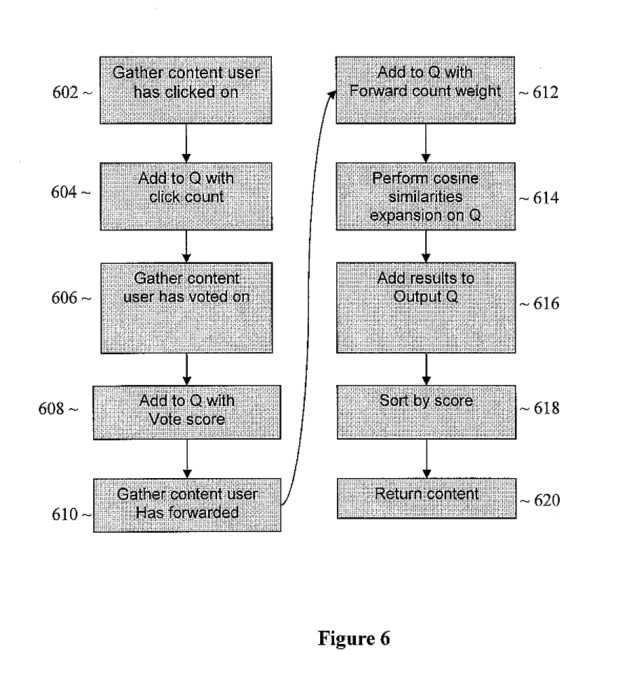

The above relationship-based approach provides one good source of information in constructing relevant content. However, the social network might not always be active, and it might not always be a good predictor. In various embodiments, the relevant content service enhances the accuracy of the prediction with a clickstream-based cosine similarities model, FIG. 6. The relevant content service looks at content that the user has already responded to (with a clickthrough or positive vote or other such action) and performs a cosine similarities expansion on that content (known as a seed set) to create a new base of content (604-614). This model looks at user behavior in aggregate to find content that other people who have responded to a particular seed set have responded to. This will, for example, identify correlations such as the fact that users who like Houses of the Holy often like Crossroads. The relevant content identified through this approach is added to the selected relevant content 616. At such time, again the relevant content are re-sorted by their scores 618, and the selected relevant content may be propagated to the client device, 620.

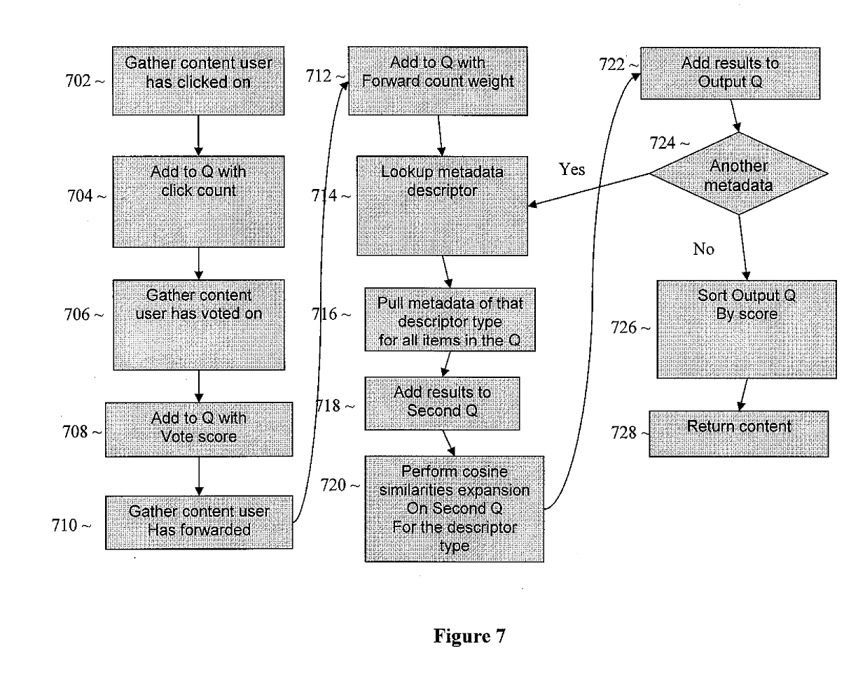

In various embodiments, the relevant content service additionally looks at metadata associated with content the user has responded to select relevant content, FIG. 7. In particular, the relevant content service looks at the tags on the content and performs a cosine similarities expansion on that tag set (704-720). This is good for suggesting that people who like things tagged “cat” often like things tagged “Siamese,” and thus we can use content tagged “Siamese” as a source for people who have responded to things tagged cat. The relevant content identified through this approach is added to the selected relevant content, 722. When all metadata of potential contribution have been examined 724, the relevant content are re-sorted by their score 726, and the selected relevant content may be propagated to the client device, 728.

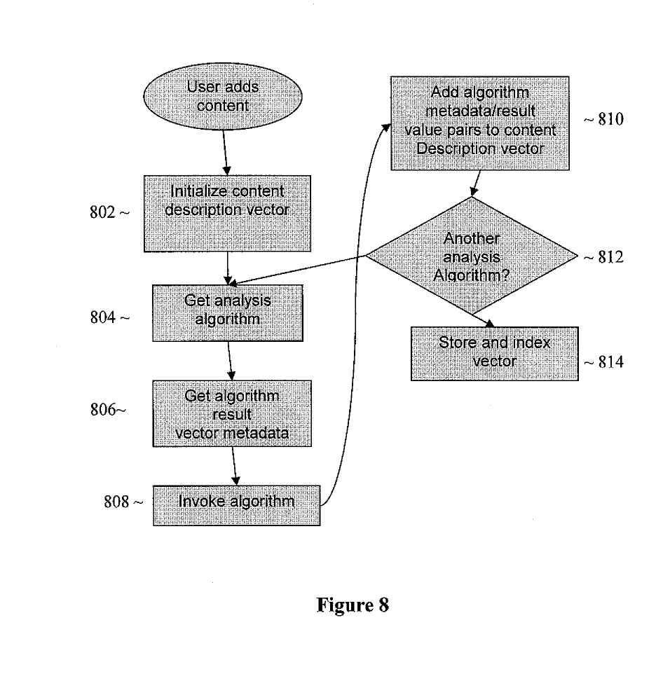

In various embodiments, the process of FIG. 8 may be employed to associate algorithm and relevant value pair to content. As illustrated, a description vector may be initialized for each content, 802. For each of the content description vector, the analysis algorithm employed are looped through 804-810, invoked at 804, its result vector metadata obtained at 806, its analysis performed at 808, and the corresponding algorithm metadata/result pair placed into the content description vector at 810. The process is repeated for all analysis algorithms 812. At the end of the process, the content description vectors are stored and indexed 814.

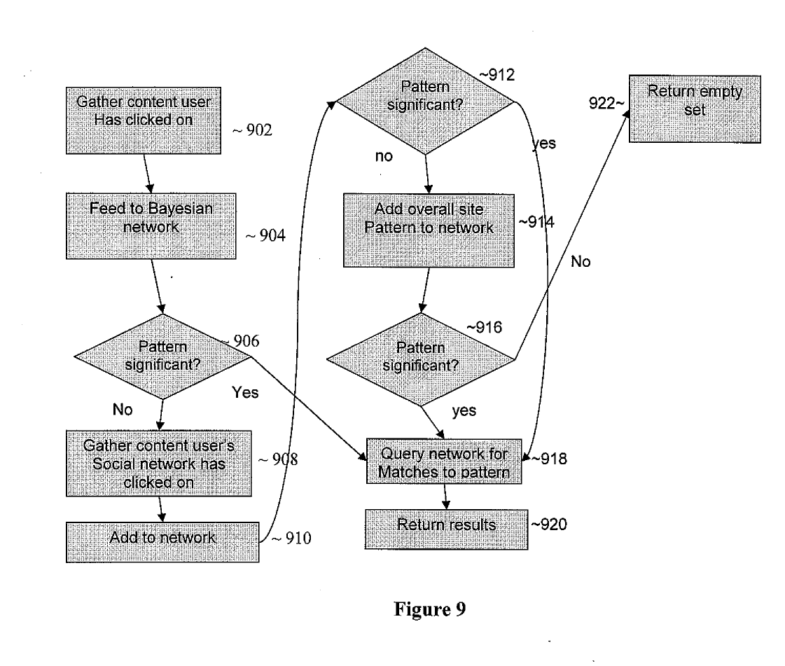

In various embodiments, the relevant content service further employs a Bayesian system that analyzes a particular user's patterns to attempt to learn what might be useful to send them, FIG. 9. With such a model, the relevant content service might determine that a particular user most often likes images that have a high red component. For this model, the relevant content service extracts a number of properties (called dimensions) of objects, 902, 908 and 914, feeds the properties to a Bayesian network 904, 910 and 914, and determines their relevance, 906, 912 and 916. These can be things such as parameters of a Daubechies wavelet compression for images, wordnet analysis for text, and what artists or genres a person listens to. Because the Bayesian network requires a lot of information to train it, the relevant content service may use the weighting factors of the person's social network when the user hasn't performed enough interaction with the site. In the case of the person's social network not having enough activity, the relevant content service uses overall site activity to populate the weighting factors. If no relevant content are found, the relevant content service may return an empty set 922. If relevant content are found, the relevant content may be propagated.

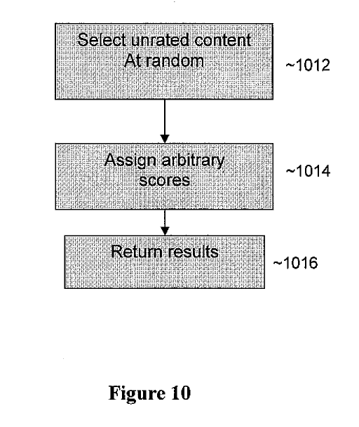

In various embodiments, the relevant content service may additionally inject (e.g. randomly or pseudo-randomly) a set of content that hasn't yet been clicked on, and for which there is therefore no response data about it, into the queue into a mix of locations (see e.g. FIG. 10, 1012-1016). This will let the relevant content service develop response data on content that otherwise has none.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. A method to propagate content or metadata comprising:
receiving by one or more servers reporting of user activity associated data respectively associated with a plurality of client devices;
determining by the one or more servers a plurality of patterns relevant to the client devices or users of the client devices, based at least in part on the respective reported user activity associated data of the client devices;
selectively propagating by the one or more servers a plurality of messages comprising content or metadata to the client devices, based at least in part on the determined patterns relevant to the client devices or users of the client devices.

2. The method of claim 1 further comprising generating the messages comprising content or metadata.

3. The method of claim 1 wherein the determining comprises determining by the one or more servers the relevant patterns, employing a plurality of pattern analysis algorithms.

4. The method of claim 3 further comprising at least one of the one or more servers managing the pattern analysis algorithms to be employed by the one or more servers.

5. The method of claim 3, wherein the pattern analysis algorithms comprise one or more of:
a distance function configured to analyze relationship distances between client devices;
a cosine function configured to analyze similarity between user activities;
a Baysesian function configured to predict relevancy of a content or metadata.

6. The method of claim 1, wherein the user activity associated data includes actively associated and passively associated data.

7. The method of claim 1, wherein the received user activity associated data have been previously filtered.

8. The method of claim 1, wherein the received user activity associated data have been previously modified.

9. The method of claim 1, wherein the receiving further comprises receiving other data of interest created in response to trigger events generated based on the observed user activity associated data, and the determining being based instead or additionally on the other data of interest.

10. The method of claim 9, wherein the received other data of interest have either been previously filtered or been previously modified.

11. The method of claim 1, wherein the receiving further comprises receiving analysis results of the user activity associated data, the analysis having been performed on the user activity associated data, in a filtered or unfiltered manner, or in a modified or unmodified manner, and the determining being based instead or additionally on the received analysis results.

12. An apparatus comprising:
one or more processors; and
storage medium coupled to the one or more processors, and having a plurality of programming instructions stored therein, the programming instructions being configured to implement a plurality of subsystems or services to be operated by the one or more processors, including:
a pattern matching subsystem to determine a plurality of patterns relevant to a plurality of client devices or users of the client devices, based at least in part on respective reported user activity associated data of the client devices, and
at least one of
a data collection and management subsystem to receive the user activity associated data respectively associated with the plurality of client devices, or
a message propagating subsystem to selectively propagate a plurality of messages comprising content or meta data to the client devices, based at least in part on the determined patterns relevant to the client devices or users of the client devices.

13. The apparatus of claim 12, wherein the apparatus comprises both the data collection and management subsystem and the message propagating subsystem.

14. The apparatus of claim 12, wherein the subsystems or services further include a message generator configured to generate the messages comprising content or metadata.

15. The apparatus of claim 12, wherein the pattern matching subsystem is configured to determine the relevant patterns, employing a plurality of pattern analysis algorithms.

16. The apparatus of claim 15, wherein the subsystems or services further include an algorithm manager to manage the pattern analysis algorithms to be employed by the apparatus and other apparatuses, the apparatuses collectively implementing a content or metadata propagation service

17. The apparatus of claim 15, wherein the programming instructions further implement the pattern analysis algorithms comprising one or more of:
a distance function configured to analyze relationship distances between client devices;
a cosine function configured to analyze similarity between user activities;
a Baysesian function configured to predict relevancy of a content or metadata.

18. An article of manufacture comprising
storage medium; and
a plurality of programming instructions stored therein, the programming instructions configured to program an apparatus to implement on the apparatus one or more subsystems or services, including:
a data collection and management subsystem to receive user activity associated data respectively associated with a plurality of client devices,
a pattern matching subsystem to determine a plurality of patterns relevant to the plurality of client devices or users of the client devices, based at least in part on respective reported user activity associated data of the client devices,
a message generator to generate the messages comprising content or metadata, and
a message propagating subsystem to selectively propagate a plurality of messages comprising content or meta data to the client devices, based at least in part on the determined patterns relevant to the client devices or users of the client devices.

19. The article of claim 18 wherein the pattern matching subsystem is configured to determine the relevant patterns, employing a plurality of pattern analysis algorithms.

20. The article of claim 19, wherein the programming instructions are configured to also implement the plurality of pattern analysis algorithms.

21. The article of claim 18 wherein the subsystems or services further comprises an algorithm manager to manage the pattern analysis algorithms to be employed by the apparatus and other apparatuses, the apparatuses collectively implementing a content or metadata propagation service
